(19) United States
(12) Patent Application Publication
(10) Pub. No.: US 2015/0129262 A1
(43) Pub. Date: May 14, 2015

(54) TILLAGE IMPLEMENT SCRAPER ASSEMBLY

(71) Applicant: CNH Industrial America LLC, New Holland, PA (US)

(72) Inventors: Michael G. Kovach, Morton, IL (US); Eric J. Anderson, Metamora, IL (US)

(73) Assignee: CNH INDUSTRIAL AMERICA LLC, New Holland, PA (US)

(21) Appl. No.: 14/525,867

(22) Filed: Oct. 28, 2014

Related U.S. Application Data
(60) Provisional application No. 61/903,439, filed on Nov. 13, 2013.

(51) Int. Cl. A01B 15/16; A01B 5/04

(52) U.S. Cl. CPC A01B 15/16; A01B 5/04
USPC 172/558

(57) ABSTRACT

An agricultural tillage implement including a carriage frame assembly and pull hitch towed by a tractor, and secondary frames supported by the carriage frame assembly. The secondary frames mount gangs of disk blades for tilling the soil in a travel direction. Scraper assemblies are mounted on the secondary frames for scraping soil and residue from the disk blades.

### CROSS REFERENCE TO RELATED APPLICATIONS

This is a non-provisional application based upon U.S. provisional patent application Ser. No. 61/903,439 entitled “TILLAGE IMPLEMENT SCRAPER ASSEMBLY”, filed Nov. 13, 2013, which is incorporated herein by reference.

### BACKGROUND OF THE INVENTION

1. Field of the Invention

The present invention relates to agricultural implements, and, more particularly, to agricultural field tillage implements.

2. Description of the Related Art

Farmers utilize a wide variety of tillage implements to prepare soil for planting. Some such implements include two or more sections coupled together to perform multiple functions as they are pulled through the fields by a tractor, for example, a cultivator/harrow which is capable of simultaneously tilling and leveling the soil in preparation for planting. This implement includes a cultivator that is towed by a tractor and a harrow that is towed by the cultivator.

In one type of tilling operation, rows or gangs of circular disk blades are pulled through the soil at variable depths to break up clods or lumps of soil, as well as old plant material to provide a more amenable soil structure for planting and to level the soil surface. The gangs of disks are arranged on frames that extend generally laterally with respect to the direction of movement through a field and more particularly are angled with respect to the direction of movement.

As tillage operations have been developed to be more efficient, the implements are being called upon to operate in evermore increasing extremes of conditions. At the same time, the tillage implements are being expanded in size to provide greater efficiency in processing the soil. Tillage implements are expected to operate in wetter conditions to minimize the effect of weather on the farming operation.

With conditions such as described above, there is a tendency for soil to accumulate on the disk blades. This can be a particular problem for disk blades that are positioned generally more outboard on the implement frame, at positions where the fore and aft clearances between the disk blades and angular frame members are reduced in comparison to more inboard locations. These locations are often adjacent the disk blades that are at the bearing hangers that support the gangs of disk blades for rotation and soil penetration below the implement frame. Accumulation on the disk blades prevents smooth flow of soil and residue through the equipment, and more particularly between adjacent disk blades and between associated equipment structures, such as frame members. Operators then need to remove the obstructions by raising the implement out of the ground, or by removing the accumulated soil and residue by hand. Scrapers have been proposed but have been bulky, often including a separate support member, such as an angle iron segment, that is fastened to the implement frame and spans several disk blades. Individual scrapers for each disk blade are connected to the support member. The support members and scraper connections to the support members further reduce the open area between adjacent disks and between disk blades and the implement frame.

What is needed in the art is a tilling implement that minimizes build up of soil and residue on the disk blades without additional and complicated mechanisms.

### SUMMARY OF THE INVENTION

The present invention provides a tillage implement having scrapers for removing soil and plant residue build-up on the tillage implement.

In one form, the invention is an agricultural tillage implement including a carriage frame assembly with a pull hitch extending in a travel direction. Secondary frames extend generally laterally with respect to the travel direction. Gangs of disk blades are journaled by and supported by a bearing hanger mounted to the secondary frames to till soil over which the tillage implement traverses. A scraper assembly has a base connected to one of the secondary frames, an arm extending from the base and a scraper blade connected to the arm. The scraper blade is supported closely adjacent to a disk blade to scrape residue away from the disk blade.

In another form, the invention is a scraper assembly for a disk blade of an agricultural tillage implement having a frame member and a disk blade carried by the frame member. The scraper assembly includes a base connected to the frame member, an arm extending from the base and a scraper blade connected to the arm. The scraper blade is supported closely adjacent to the disk blade to scrape residue away from the disk blade.

An advantage of the tillage implement and scraper assembly disclosed herein is that the disk blades and their support elements are kept substantially free of soil and residue.

Another advantage of the tillage implement and scraper assembly disclosed herein is that scraper assembly can be used effectively in congested areas of the implement.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a tillage implement having a scrapper for disk blades as disclosed herein, the tillage implement shown being pulled by a tractor;

FIG. 2 is a perspective view of the tillage implement of FIG. 1;

FIG. 3 is a fragmentary perspective view of the tillage implement of FIGS. 1 and 2;

FIG. 4 is another fragmentary perspective view of the tillage implement of FIGS. 1-3, showing the implement from an angle different from that of FIG. 3;

FIG. 5 is yet another fragmentary perspective view of the tillage implement of FIGS. 1-4, shown from an angle different from those of the previous drawings;

FIG. 6 is a perspective view of the disk scraper shown on the tillage equipment in FIGS. 1-5; and

FIG. 7 is another perspective view of the disk scraper shown from an angle different than that shown in FIG. 6.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

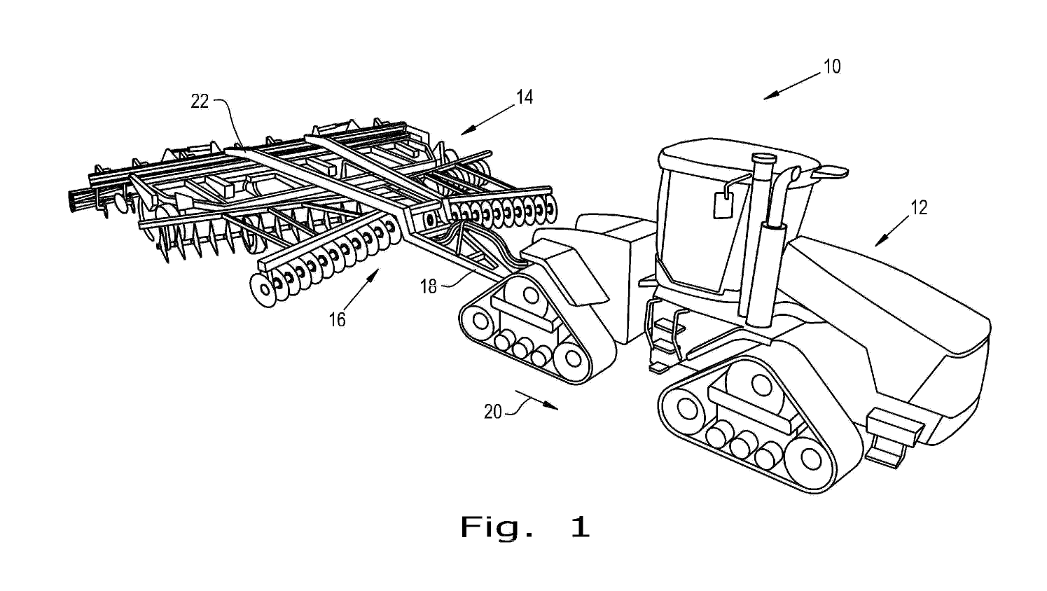

Referring now to the drawings, and more particularly to FIG. 1, there is shown a tillage apparatus 10 which generally includes a tractor 12 and an agricultural tillage implement 14 for tilling and finishing soil prior to seeding.

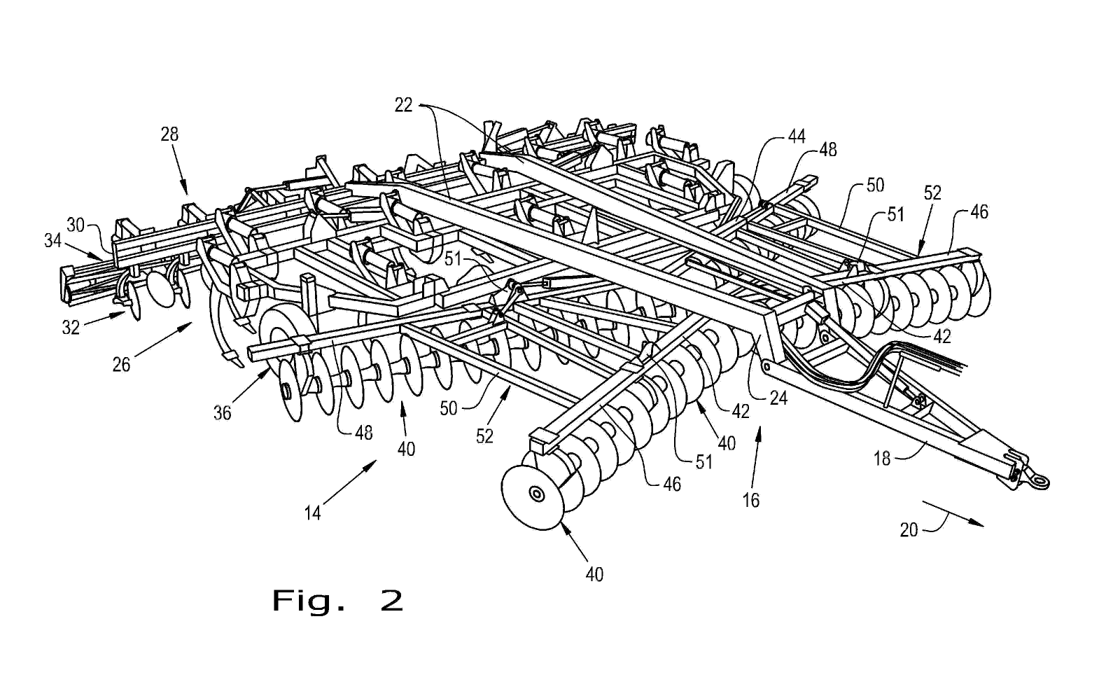

Now, additionally referring to FIG. 2, agricultural tillage implement 14 is configured as a multi-section field disk ripper 14, and includes a carriage frame assembly 16. Carriage frame assembly 16 is the section that is directly towed by a traction unit, such as agricultural tractor 12. Carriage frame assembly 16 includes a pull hitch 18 generally extending in a travel direction 20, and forward and aft directed carrier frame members 22 which are coupled with and extend from pull hitch 18. Reinforcing gusset plates 24 may be used to strengthen the connection between pull hitch 18 and carrier frame members 22. Carriage frame assembly 16 generally functions to carry a shank frame 26 for tilling the soil, and a rear implement 28 for finishing the soil. Rear implement 28 includes a secondary frame 30, leveling blades 32 and rolling (aka, crumbler) basket assemblies 34, which co-act with each other to finish the soil in preparation for planting. Leveling blades 32 and rolling basket assemblies are both attached to secondary frame 30.

Wheel assemblies 36, only one of which is shown, are actuated from tractor 12 to raise or lower the carrier frame members 22 to place the tillage apparatus in a transport position with the wheel assemblies 36 supporting the implement above the ground or an operating position in which the tillage equipment is used to till the soil.

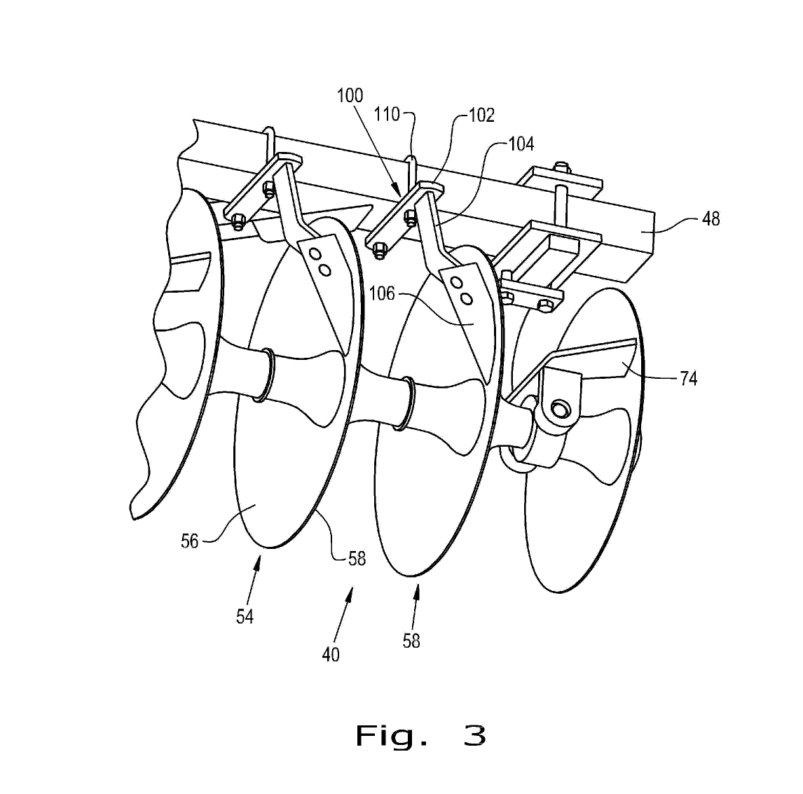

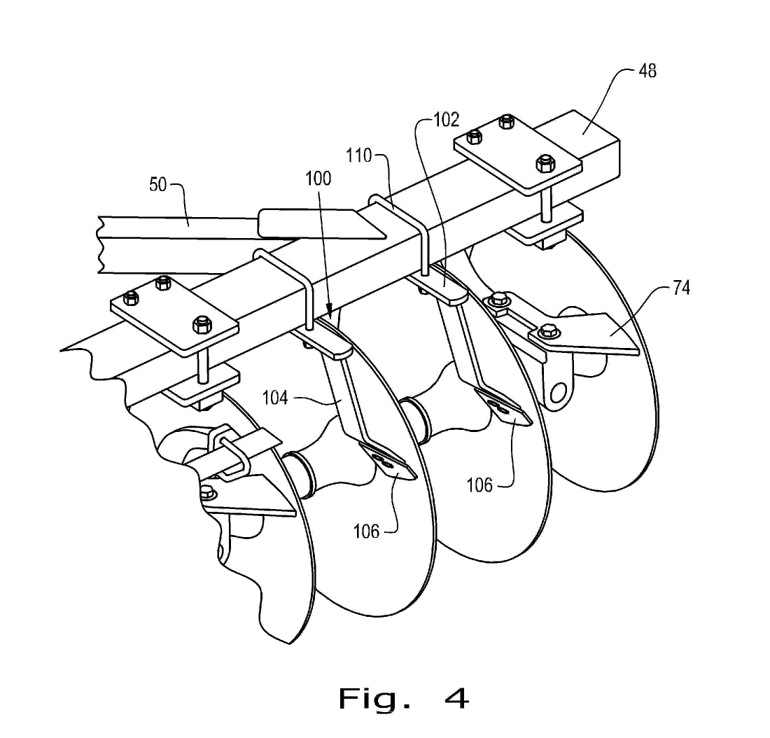

Referring now more particularly to FIGS. 3-5, there is shown a portion of a secondary disk frame assembly 38 which provides support for gangs of disk blades 40. Disk frame assembly 38 includes forward and aft frame secondary frame members 42 and 44, respectively, as shown in FIG. 2. Outboard secondary frame members 46, 48 are provided at outer ends of forward and aft frame members 42, 44, respectively. Outboard frame members 46, 48 are structurally interconnected by a plurality of reinforcing frame members 50. A pivot joint 51 is positioned between each outboard frame member 46, 48 and an associated forward or aft frame member 42, 44. Pivot joints 51 provide pivoting support for wing sections 52 each including a forward and aft outboard frame member 46, 48 interconnected by reinforcing frame members 50. Wing sections 52 are pivoted between a field operating position in which they are generally horizontal with respect to the disk frame 38 and a transport position in which they are pivoted out of the plane for appropriate road clearance during the transport mode.

As shown particularly in FIG. 3, the gangs of disk blades 40 each have individual disk blades 54 having a concave side 56 and convex side 58. The individual disks 54 are each sandwiched between central shaft assemblies 60 to interconnect the disk blades and cause them to rotate about a common axis. As noted previously, the gangs of disk blades 40 are at an angle with respect to the travel direction 20. This promotes a more effective tilling of the soil. At periodic intervals along the gangs of disk blades 40, there are positioned bearing hanger assemblies 64 mounted to and supported from the frame members 42, 44, 46, 48 by C-shaped structures 66. As shown in FIGS. 3-5, each bearing hanger assembly 64 is mounted to a lower section 68 of C-shaped support element 66. A top section 70 is connected to lower section 68 by a plurality bolts 72. In the exemplary illustration showing a fragmentary portion of the implement, lower section 68 and top section 70 are positioned on opposite sides of frame member 48, and held thereto by clamping action established by tightening bolts 72. The C-shaped elements 66 provide a degree of flexibility resiliency for the gangs of disk blades 40 to improve tillage operations. A scraper/deflector 74 is mounted adjacent bearing hanger assembly 64. In more open areas of disk frame assembly 38, a scraper support 76 is connected between pedestals 78 fastened to lower sections 68, and span the disk blades 54 between the adjacent bearing hanger assemblies 64. Disk scrapers 80 connected to scraper support 76 operate against the disk blades 54 below scraper support 76.

Individual scraper assemblies 100 are connected directly to and fastened on frame members 42, 44, 46 or 48, in at least some areas of disk frame assembly 38, such as areas that are more congested with frame members, reinforcing members or other structures and components of tillage apparatus 10. Each such scraper assembly 100 is provided for an individual and different disk blade 54, and comprises a base 102, an arm 104 and a scraper blade 106. Base 102 comprises the structure for mechanical connection of scraper assembly 100 on a frame member of disk frame assembly 38. In the exemplary embodiment shown, base 102 defines holes 108 for receiving a fastener or fasteners 110, such as a U-bolt 110 for attaching assembly 100 to the frame member, such as frame member 48 as shown. While a U-bolt 110 is shown in the exemplary embodiment, it should be understood that other types of mechanical fastening also can be used, such as, for example and not limitation, straight bolts extending along opposite sides of the frame member between base 102 and a plate on an opposite side of the frame member from base 102, or bolts extending through the frame member and base 102. Still other types of mechanical fasteners also can be used.

Arm 102 is an angularly oriented structure including a proximal portion 112 rigidly connected to, or integral with base 102, and a distal portion 114 directed toward concave side 56 of disk 54. Scraper blade 106 is connected to distal portion 114 such as by removable fasteners 116, which may be rivets 116, for example. Scraper blade 106 can be removed and replaced if worn excessively or damaged. Scraper blade 106 extends outwardly from arm 104, and terminates in a curved scraper edge 118 that conforms to the concave side 56 of individual disk blades 54.

Scraper assembly 100 can be adjusted toward and away from the disk blade 104 against which it operates by loosening fastener or fasteners 110 and changing the relative position of the scraper assembly on the frame member 42, 44, 46 or 48 to which it is fastened. If mechanical fasteners extending through a frame member and base 102 are used, holes in the base or frame member can be elongated or over-sized to allow sliding adjustment. If a U-bolt fastener 110 or other fastening system surround the frame member is used, no modification of the holes may be required. Accordingly, a degree of adjustment is provided between the curved edge 118 of the scraper/blade 106 and the concave side 56 of disk blade 54 from the adjustable positioning of scrapper assembly 100 on the frame member 42, 44, 46 or 48 on which it is installed.

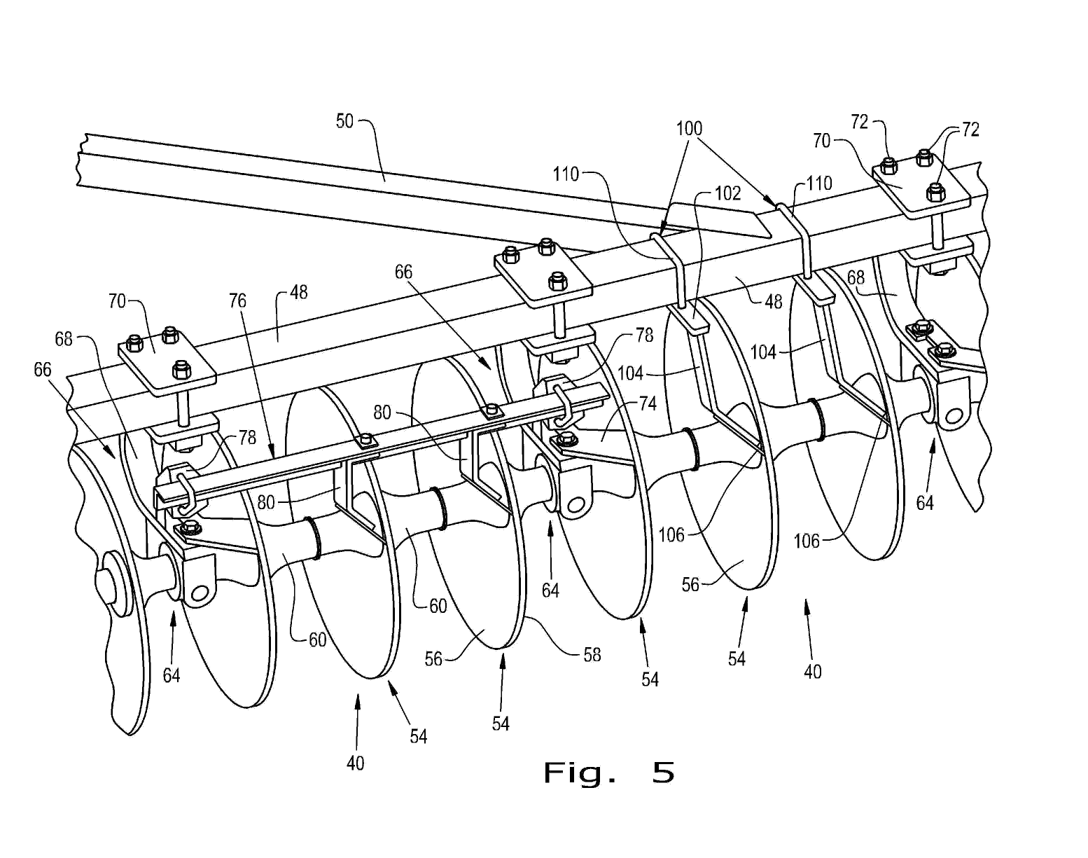

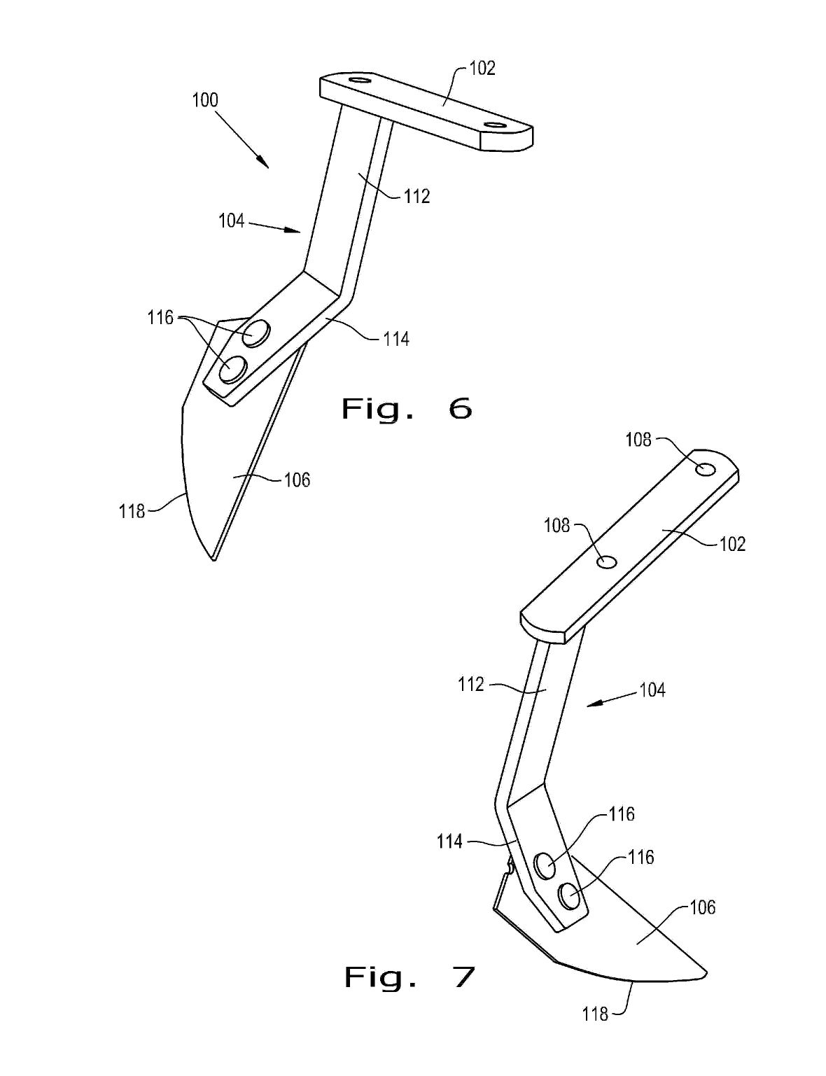

As shown particularly in FIGS. 5-7, arm 104 is made of flat bar-like material relatively thin in comparison to the width and length thereof. Arm 104 is positioned with the thickness, or edge facing generally forward. As a result, movement of the tillage implement 10 through the field causes the disk blades 54 to rotate so that the scraper blade 106 scrapes any accumulated soil and residue from the concave side 56 of disk 54. However, with the thickness or edge of arm 106 facing forward, there is only minimal surface area contributing to congestion and therefore improving material flow through tillage apparatus 10. With each scraper assembly 100 connected directly to frame member 48, without intervening structure for grouping scrapers, there is only minimal structure contributing to congestion, further improving material flow through tillage apparatus 10.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural tillage implement, comprising:
a carriage frame assembly including a pull hitch extending in a travel direction;
secondary frames extending generally laterally with respect to the travel direction; and,
gangs of disks blades connected to and supported by said secondary frames to till soil over which the tillage implement traverses; and
an individual scraper assembly for a disk blade of the gangs of disk blades, the scraper assembly having a base fastened on one of the secondary frames, an arm extending rigidly from said base and a scraper blade connected to said arm, said scraper blade being supported closely adjacent to the disk blade to scrape residue away from the disk blade.

2. The agricultural tillage implement of claim 1, wherein a removable fastener connects the scraper blade to the arm.

3. The agricultural tillage implement of claim 2, further comprising a U-bolt connecting the base on the secondary frame.

4. The agricultural tillage implement of claim 1, wherein an adjustable mechanical fastener connects the scraper assembly on the secondary frame.

5. The agricultural tillage implement of claim 1, wherein the disk blades have a concave side and a convex side, and said scraper blade is positioned adjacent the concave side of the disk.

6. The agricultural tillage implement of claim 5, wherein the scraper blade has a curved scraping edge conforming to the concave side of the disk.

7. The agricultural tillage implement of claim 6, in which the arm has a thickness thereof that is less than a width thereof, and the arm is positioned with the thickness thereof generally facing the travel direction.

8. The agricultural tillage implement of claim 1, in which the arm has a thickness thereof that is less than a width thereof, and the arm is positioned with the thickness thereof generally facing the travel direction.

9. The agricultural tillage implement of claim 8, further comprising an adjustable mechanical fastener connecting the base on the secondary frame.

10. The agricultural tillage implement of claim 9, wherein a removable fastener connects the scraper blade to the arm.

11. A scraper assembly for a disk blade of an agricultural tillage implement having a frame member and a disk blade carried by the frame member, the scraper assembly comprising:
a base directly connected to and adjustably positionable on the frame member;
an arm integral with said base; and
a scraper blade connected to said arm, said scraper blade being supported closely adjacent to the disk blade to scrape residue away from the disk blade.

12. The scraper assembly of claim 11, wherein a removable fastener connects the scraper blade to the arm.

13. The scraper assembly of claim 12, further comprising a U-bolt connecting the base to the frame member.

14. The scraper assembly of claim 11, wherein the disk blades have a concave side and a convex side, and the scraper blade is positioned adjacent the concave side of the disk.

15. The scraper assembly of claim 14, wherein the scraper blade has a curved scraping edge conforming to the concave side of the disk.

16. The scraper assembly of claim 15, in which the arm has a thickness thereof that is less than a width thereof, and the arm is positioned with the thickness thereof generally facing forward relative to a travel direction of the implement in use.

17. The scraper assembly of claim 11, in which the arm has a thickness thereof that is less than a width thereof, and the arm is positioned with the thickness thereof generally facing forward relative to a travel direction of the implement in use.

18. The scraper assembly of claim 11, further comprising a mechanical fastener connecting the base to the frame member.

19. The scraper assembly of claim 19, wherein a removable fastener connects the scraper blade to the arm.
